(19) United States
(12) Patent Application Publication
(10) Pub. No.: US 2025/0218607 A1
(43) Pub. Date: Jul. 3, 2025

(54) MANAGING BYPRODUCTS IN A FUSION REACTOR AND PUMPING SYSTEMS FOR THE SAME

(71) Applicant: TAE Technologies, Inc., Foothill Ranch, CA (US)

(72) Inventor: Daniel Scott Marshall, Chandler, AZ (US)

(21) Appl. No.: 18/852,317

(22) PCT Filed: Mar. 28, 2023
(86) PCT No.: PCT/US2023/016559

§ 371 Date: Sep. 27, 2024

Related U.S. Application Data
(60) Provisional application No. 63/324,398, filed on Mar. 28, 2022.

(51) Int. Cl. G21B 1/11; B01D 53/46; G21B 1/13

(52) U.S. Cl. CPC G21B 1/115; B01D 53/46; G21B 1/13; B01D 2251/302; B01D 2251/304; B01D 2251/306; B01D 2257/108; B01D 2257/11; B01D 2259/818

(57) ABSTRACT

Methods, systems, and apparatus include using an alkali metal as working fluid of a diffusion pump to remove hydrogen and/or helium from a reaction chamber of a nuclear fusion reactor. One example system includes a nuclear fusion reactor, a diffusion pump with a working fluid comprising an alkali metal, the diffusion pump being arranged to remove hydrogen and/or helium from the nuclear fusion reactor during operation of the system.

### CROSS-REFERENCE TO RELATED APPLICATIONS

This application claims priority under 35 USC § 119 (e) to U.S. Patent Application Ser. No. 63/324,398, filed on Mar. 28, 2022, the entire contents of which are hereby incorporated by reference.

### FIELD OF INVENTION

The present invention relates to byproduct management in nuclear reactor systems and related pumping systems.

### BACKGROUND

In nuclear fusion, two or more atomic nuclei react to form one or more atomic nuclei and possibly subatomic particles. The process can either release or absorb energy, depending on the exact atoms undergoing fusion. Controlled fusion can be used to generate electricity. The efficiency of this generation depends strongly on environmental factors, especially when certain materials must achieve the plasma phase. Removing byproducts and unusable fuel from the environment can enhance the fusion reaction.

### SUMMARY

Aneutronic fusion is a form of fusion which releases energy via charged particles such as alpha particles (helium nuclei) instead of neutrons. As a result, there is generally no neutron radiation or its dangerous side effects. Additionally, converting charged particles into electrical energy is more feasible than doing so with neutrons, making it an attractive choice for power generation.

One example of nuclear fuel for aneutronic fusion is ionized hydrogen and boron-11, or proton-boron-11 (pB11). When these pairs fuse, three alpha particles are formed. While these charged particles are the source of electrical power generation, their presence can inhibit subsequent fusion reactions. Furthermore, ionized hydrogen can lose power to bremsstrahlung radiation and can become too cold to undergo fusion. The presence of cold hydrogen can further hinder the reaction between other proton-boron-11 pairs. Removing these byproducts (i.e., cold hydrogen and/or helium) from a reactor can therefore enhance the efficiency of generating electricity.

The embodiments disclosed herein offer ways to manage such byproducts by facilitating their removal from the fusion reactor. In some examples, the byproducts can be reinserted into the reactor as fuel.

Removal of these byproducts can be performed using alkali metals, e.g., lithium, which chemically react with hydrogen. This reaction makes alkali metals suitable for capturing the cold hydrogen. As a noble gas, helium doesn't generally react with other materials in its ground state. In plasma conditions commonly ubiquitous in a fusion reactor, however, it can interact with lithium vapor. One way to take advantage of these chemical properties is to use alkali metals as a working fluid in a diffusion pump. Most pumps struggle to efficiently pump hydrogen and helium due to these elements' small size and mass. However, the reactive and interactive aspects of alkali metals with hydrogen and helium respectively can make this arrangement effective. In addition, or alternatively, heavier alkali metals, such as sodium, potassium, rubidium, and cesium, and alkali earth metals can be used.

In conventional diffusion pumps, chemical interactions between the working fluid and source gas are often undesirable, as this leads to additional steps being needed to prepare the working fluid for recycling. However, this specification describes a system where the interactions are favorable in turning nuclear fusion byproducts into fuel, including useful isotopes of hydrogen.

In general, in a first aspect, this specification describes a method that includes using an alkali metal as working fluid of a diffusion pump to remove hydrogen and/or helium from a reaction chamber of a nuclear fusion reactor.

Implementations of this aspect can include one or more of the following features and/or features of other aspects. For example, in some implementations, using the alkali metal includes delivering a vapor of an alkali metal into a chamber containing the hydrogen and/or helium, under conditions so that the vapor of the alkali metal forms a condensate on at least one interior wall of the chamber. The condensate can include the alkali metal. In some implementations, the condensate includes a reaction product of the alkali metal and hydrogen and/or helium.

In some implementations, the chamber containing the hydrogen and/or helium is a reaction chamber in which a nuclear fusion reaction occurs. In some implementations, the chamber is separate from and in fluid communication with a reaction chamber in which a nuclear fusion reaction occurs. For convenience in describing such implementations, the chamber may be referred to as a pump chamber.

In some implementations, the nuclear fusion reaction is a pB11 reaction.

Some implementations further include removing the condensate from the chamber.

Using the alkali metal can include heating the alkali metal prior to delivering the alkali metal into the chamber.

Some implementations further include delivering a coolant to cool the interior wall of the chamber to provide the conditions to form the condensate.

Some implementations further include energizing a plasma to ionize atomic helium entering the chamber.

In some implementations, the alkali metal is lithium, sodium, or potassium. In some implementations, the alkali metal is lithium.

In general, in another aspect, this specification describes a system that includes a nuclear fusion reactor and a diffusion pump with a working fluid that is or includes an alkali metal, the diffusion pump being arranged to remove hydrogen and/or helium from the nuclear fusion reactor during operation of the system.

Implementations of this aspect can include one or more of the following features and/or features of other aspects.

In some implementations, the diffusion pump includes a chamber arranged to receive hydrogen and/or helium from the nuclear fusion reactor, a supply conduit including one or more nozzles for delivering a vapor of the working fluid including the alkali metal to the chamber, and an exhaust conduit for removing a condensate of the vapor that forms on an interior chamber wall from the chamber.

In some implementations, the chamber is a reaction chamber of the nuclear fusion reactor. In other implementations, the chamber is separate from a reaction chamber of the nuclear fusion reactor.

Some implementations further include a backing pump in fluid communication with the chamber via the exhaust conduit, the backing pump being configured to draw the condensate from the chamber. Some implementations further include a heater arranged to heat the working fluid including the alkali metal. Some implementations further include a reservoir containing the alkali metal in fluid communication with the supply conduit. Some implementations further include a coolant conduit arranged to cool the interior wall of the chamber. Some implementations further include a plasma generator for ionizing helium in the chamber. Some implementations further include a reservoir containing the working fluid including the alkali metal.

The alkali metal can be lithium, sodium, or potassium. In some implementations, the alkali metal is lithium.

Among other advantages, the methods and systems disclosed herein can enhance the efficacy of power generation through controlled fusion. The choice to use a chemical reaction to trap unwanted particles in the nuclear reactor allows the removal of light atoms, such as hydrogen and helium. Pumps usually struggle with lighter atoms such as these, due to their small size. However, the reaction between alkali metals and hydrogen forms alkali hydride solids, which can be filtered from the molten metal formed on the walls of the chamber. Additionally, the chemical reaction between cold hydrogen and alkali metals can be a source of refined nuclear fuel.

Conventional diffusion pumps typically use an oil to pump a gas. Back-streaming, or the leaking of the working fluid into the vacuum chamber, is difficult to completely avoid. Oil may hamper the fusion reaction and contaminate the reactor. In contrast, the inventors have learned that lithium is tolerated reasonably well by fusion systems. Alkali metals also have favorable melting points and temperature dependent vapor pressure curves for use in a diffusion pump in a system with aneutronic fusion. Further, a diffusion pump meant to pump helium can be efficient in a setting where the helium is in the plasma phase. Another advantage of this configuration is preventing damage due to high energy ion impacts to the pump walls, as a layer of molten alkali metal will form there.

### BRIEF DESCRIPTION OF THE DRAWINGS

FIG. 1A is a schematic diagram of an example fusion reactor system that includes a diffusion pump.

FIG. 1B is a cross sectional view of the same fusion reactor system.

FIG. 2A shows a diffusion pump and its components in more detail. FIG. 2B is the same diffusion pump, but shows the hydrogen and helium source gasses and the different phases of the alkali metal within the diffusion pump.

FIG. 3A is a schematic diagram of an example fusion reactor system that includes a diffusion pump with a plasma generator section.

FIG. 4 shows a diffusion pump with a plasma generator section and its components in more detail.

FIG. 5A a schematic of a diffusion pump wall on the interior of the reaction chamber.

FIG. 5B is a cross sectional view the same fusion reaction chamber, allowing a different view of the diffusion pump wall.

In the figures, like symbols denote like elements.

### DETAILED DESCRIPTION

Many controlled fusion reactions create undesirable byproducts. Though aneutronic fusion avoids producing neutron radiation, using certain fuels can create atoms that negatively impact the conditions for the fusion reaction. One such example fuel is proton-boron-11 (pB11). After a series of reactions, an ionized hydrogen atom and a boron 11-isotope become three alpha particles (i.e., three helium nuclei). Many environmental conditions can enhance or impede this reaction, including temperature, electric and magnetic field strengths, and the presence of degraded nuclear fuel. In pB11 reactions, bremsstrahlung radiation is a common channel for energy loss in fusion systems and can lead to low energy or “cold” hydrogen that can no longer undergo fusion. Additionally, the helium produced by the fusion process will likely not participate in any useful way and can impede the reaction. Boron that hasn't undergone fusion is relatively easy to remove from the reactor, as it gets stuck in the reactor wall due to its being a solid. Helium and cold hydrogen, however, can pose more of a problem to remove from the system, due to their small size and helium's chemical inertness.

Our approach to remove hydrogen and/or helium from such reactors is to harness the power of the reaction between alkali metals and hydrogen and/or the plasma phase of helium. When combined, hydrogen and alkali metals generally form alkali hydride solids, making alkali metals capable of capturing hydrogen. We implement this reaction in a diffusion pump apparatus where, for example, hydrogen is the source gas that is both physically pushed by a working fluid composed of an alkali metal vapor, and also chemically reacts with the vapor to form a reaction byproduct (e.g., a solid product) that is easier to remove from the system than the hydrogen. Additionally, the vapor form of an alkali metal (e.g., lithium, sodium, potassium, rubidium, cesium) can pump the plasma phase of helium. Additionally, boron-containing materials can be formed through the reaction between the working fluid and incoming gas from the fusion reactor.

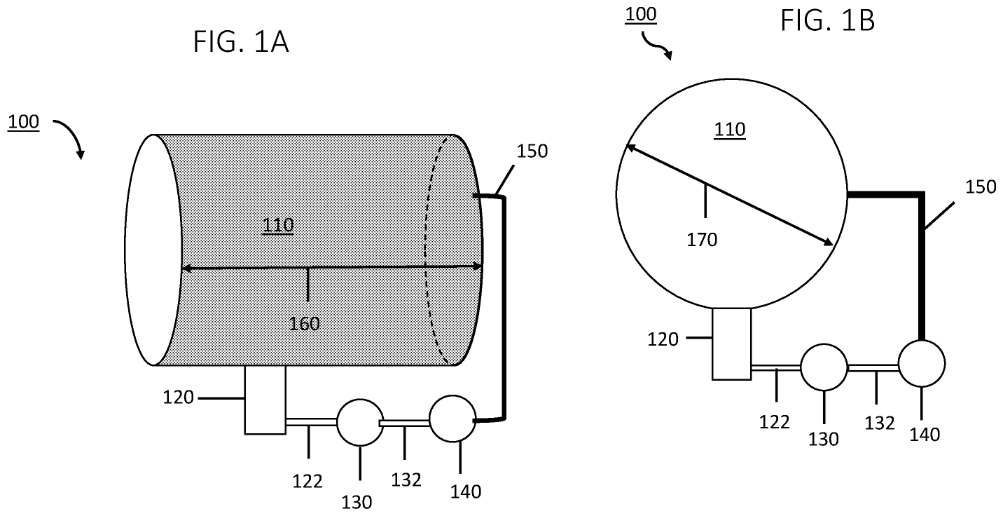

Referring to FIGS. 1A and 1B, a fusion reactor system 100 includes a fusion reaction chamber 110 attached to a diffusion pump 120. Here, the fusion reaction chamber 110 is a cylindrical chamber, and the diffusion pump 120 is arranged outside the cylindrical wall of the chamber. System 100 also include a backing pump 130 connected to the diffusion pump 120 by an exhaust conduit 122. The backing pump 130 is connected via another conduit 132 to a nuclear fuel container 140, which returns nuclear fuel recovered during the pumping process to the fusion reaction chamber 110.

During operation, fusion reactor system 100 operates by forming a plasma within the fusion reaction chamber 110 at energies sufficient to cause the nuclear fuel to fuse (e.g., for H and Boron 11 to fuse to form three He nuclei). The byproducts of this reaction (e.g., He) as well as unused nuclear fuel (e.g., H) that do not have sufficient energy to participate in the fusion reaction build up in the chamber as the reaction progresses. Diffusion pump 120 removes these reaction byproducts from the fusion reaction chamber 110, maintaining their concentrations within the reaction chamber at acceptably low levels (e.g., levels which do not significantly impede the fusion reaction).

After being pumped by the diffusion pump 120, a gas stream that contains the products of the reactions between hydrogen and helium with the alkali metal exit through an exhaust conduit 122, pulled by backing pump 130, such as a rotary vane pump, a scroll pump, or a diaphragm pump that can operate at pressures as low as 10-3 Torr.

In some implementations, the reaction in the diffusion pump provides particles that can be used as nuclear fuel, such as ionized hydrogen. The gas stream can continue through another conduit 132 to a nuclear fuel container 140 before reinsertion into the fusion reaction chamber 110 via the nuclear fuel channel 150. Although not illustrated, additional processing of the gas stream can occur before it is mixed with the nuclear fuel.

As depicted, the fusion reaction chamber 110 is cylindrical. Generally, the dimensions of the chamber can vary according to the scale/output power of the system. In some examples, the reaction chamber has a length 160 in a range from 2 meters to 100 meters (e.g., 2 meters to 20 meters, 5 meters to 12 meters). The diameter 170 can be in a range from 0.5 meters to 5 meters (e.g., from 1 meter to 3 meters, such as from 1 meter to 2 meters). Other shapes of reactor are also possible.

Generally, diffusion pump 120 is sized and shaped to be integrated with the fusion reaction chamber 110 and rest of system 100 while providing sufficient pumping capacity to maintain efficient operation of the system by removal of byproducts. For the diffusion pump 120, components of the pump that are exposed directly to the working fluid and to the fusion reactor byproducts are generally formed from a material that is nonreactive with the working fluid and byproducts. In some implementations, these components can be formed from stainless steel, which has low reactivity with, e.g., H, He, and Li and/or other alkali metals.

In general, a variety of suitable form factors can be used for diffusion pump 120. The pump at any location providing suitable access to the interior of fusion reaction chamber 110. In some implementations, more than one diffusion pump is used, e.g., where a single pump provides insufficient capacity and/or where redundancy is desired to reduce reactor downtime. Operation of diffusion pump 120 is described in detail below.

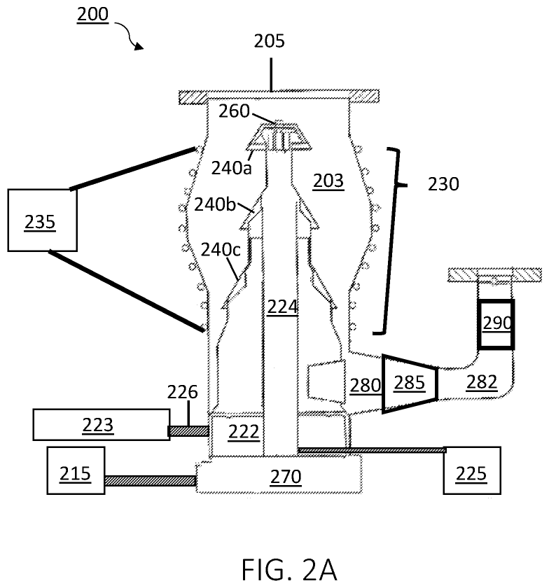

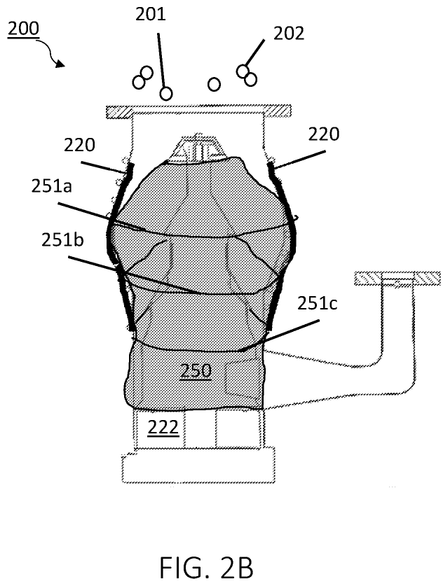

Referring to FIGS. 2A and 2B, an example of a diffusion pump 200 suitable for use in system 100 includes a pump chamber 203 with a pump inlet 205 through which hydrogen 201 (including 1H and other hydrogen isotopes, e.g., deuterium and tritium) and helium 202 (including helium-3 and helium-4) enter from the fusion reactor. The diffusion pump 200 can also pump other fuel components from the reactor. For example, in some implementations, the fusion reactor system 100 uses boron as a fuel and the diffusion pump 200 pumps boron from the reactor. At the bottom of diffusion pump 200 is a pool of a working fluid, which for convenience will be described in reference to specific implementations in which it is a pool of alkali metal 222. A working fluid pump 225 forces the alkali metal upward through a central tube 224. At various heights along the central tube 224, alkali metal vapor 250 is sprayed through multiple downward-angled rings of nozzles 240a, 240b, 240c. This creates corresponding vapor skirts 251a, 251b, 251c, which discourage particles from drifting above each individual skirt and entrain hydrogen and helium. In this example, there are three tiers of nozzle rings and alkali metal vapor skirts, but there can be any number stacked vertically, forming a nozzle assembly. In some implementations, at the top of nozzle assembly is a cold cap 260, which can condense vapor in its vicinity to control the top vapor skirt.

The walls of the diffusion pump are kept cool by cooling conduit 230. Coolant reservoir 235 supplies the cooling conduit 230 with cold coolant after contact with the diffusion pump 200 has warmed it. As the alkali metal vapor 250 encounters the cool walls, it forms alkali metal condensate 220. When the alkali metal condensate 220 and hydrogen 201 interact on the walls, they form a liquid compound that flows toward the bottom. In some implementations, there is a heater 270 at the bottom. The heater 270 encourages the alkali hydride to separate back into hydrogen and the alkali metal. The alkali metal can flow into the pool of alkali metal 222, allowing the working fluid to be recycled. The pool of alkali metal is connected to a reservoir of alkali metal 223 connected via a supply conduit 226.

In certain conditions, the alkali metal vapor can entrain the incoming gas at levels approaching the solubility limit of the liquid alkali metal. When the alkali metal condensate 220 is within certain especially hot temperatures, the entrained hydrogen and helium become less soluble in the fluid. This makes it easier for them to separate near the bottom of the diffusion pump 200, near the heater 270.

Due to the stack of vapor skirts, the pressure is higher at the bottom than it is at the top of the diffusion pump 200, which enables a backing pump 290 to remove the un-entrained source gasses. The gas stream formed in part by the processed hydrogen and helium exits through an exhaust conduit 280 before encountering a baffle 285. Then it flows through another conduit 282 as a backing pump 290, such as a rotary vane pump, a scroll pump, or a diaphragm pump that can operate at pressures, e.g., as low as 10-3 Torr, draws it out. In some implementations, the alkali hydride is filtered from the alkali metal condensate 220 and pool of alkali metal 222.

A control unit 215, such as a computer system, controls and monitors components of the diffusion pump 200 and its related components.

In general, the operating conditions (e.g., temperature and/or pressure) of the diffusion pump 200 depend on the working fluid being used. For example, heavier alkali metals, e.g., cesium and rubidium, have higher vapor pressures and lower melting points compared to lighter alkali metals, e.g., lithium and sodium. Selecting a lighter alkali metal as the working fluid for its lower vapor pressure advantageously allows for lower operating pressures, e.g., reducing energy consumption in achieving a particular pressure of the working fluid. Selecting a heavier alkali metal as the working fluid for its lower melting point advantageously allows for lower operating temperatures, e.g., reducing energy consumption in obtaining a liquid phase of the working fluid. Further, heavier alkali metals benefit from their greater mass, which allows for more momentum transfer with the source gas, which is part of the mechanism of the diffusion pump. Due to the various phases of alkali metals in the diffusion pump, there are operating temperatures ranges specific to each region. The pool of alkali metal 222 can be kept at a temperature at which the metal is liquid or vapor by the heater 270. In some cases, the alkali metal condensate 220 on the walls can range in temperature from 20° C.-1,500° C. (e.g., 500° C. or more, 600° C. or more, 700° C. or more, 800° C. or more, up to 1,200° C. or less, 1,000° C. or less).

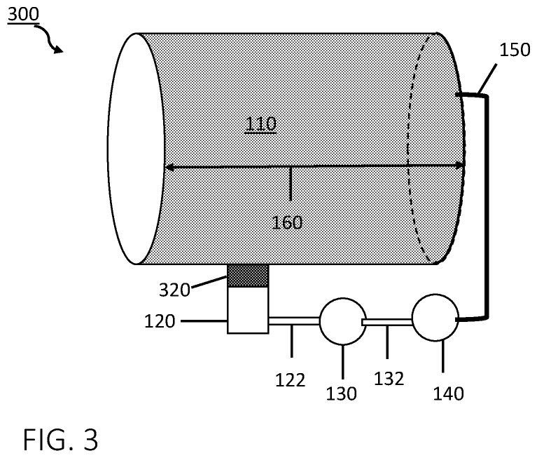

Additional elements that offer performance advantages are added to the fusion reactor system in some implementations. For example, FIG. 3 is a schematic diagram of an example fusion reactor system 300 that includes a diffusion pump 120 with a plasma generator. The diffusion pump 120 is attached to a fusion reaction chamber 110 that includes a plasma generator section 320 to enhance the pumping of the source gas. Lithium has been shown to pump ionized helium. Although the pB11 reaction produces positively-charged helium nuclei, they do not always remain ionized in the fusion reaction chamber. Therefore, in such implementations, before the hydrogen and helium enter the diffusion pump, they pass through the plasma generator section 320. The plasma generator section can include cryogenic louvers that create radio-frequency (RF) discharge. An example material that would support the RF discharge is glass.

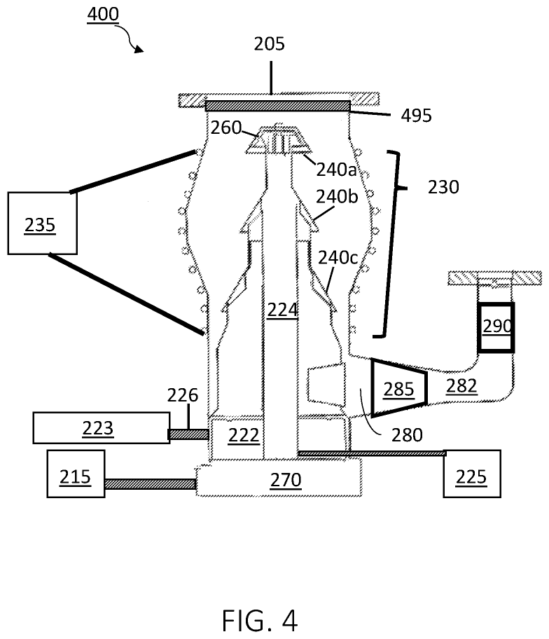

FIG. 4 shows a diffusion pump 400 with a plasma generator section 495 in more detail. When source gasses such as hydrogen and helium flow into the diffusion pump 400 through the pump inlet 205, they encounter a plasma generator section 495, which causes it to achieve the plasma phase. Alkali metals can better pump helium in the plasma phase.

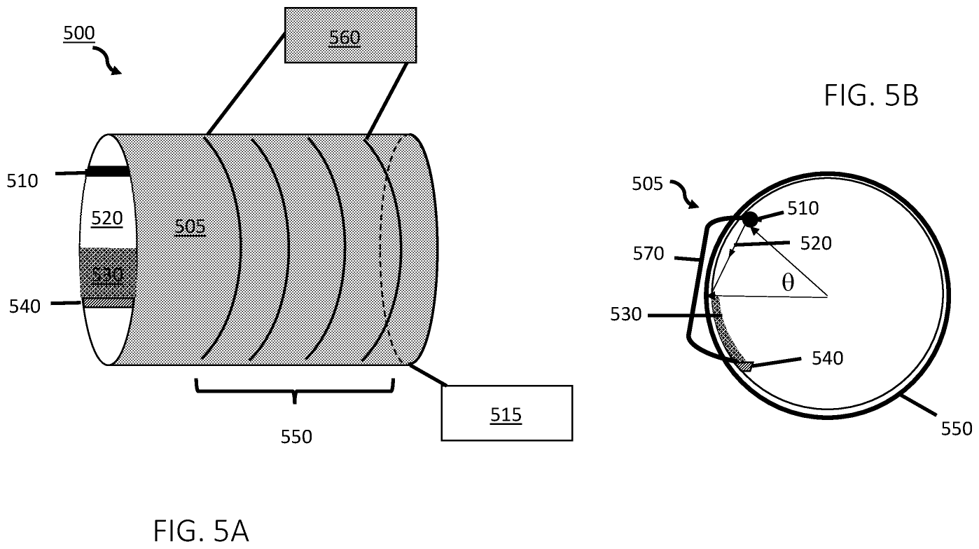

While the prior examples feature a diffusion pump that is located outside of the fusion reaction chamber, in certain implementations the pumping mechanism is implemented within the reaction chamber itself. For example, referring to FIG. 5A, fusion reaction system 500 includes a fusion reaction chamber 505 with pumping capabilities. In this example, a vapor form of the alkali metal enters the fusion reaction chamber 505 through vapor source 510 which runs along the edge of the interior of the chamber. The direction of its spraying creates an alkali metal vapor curtain 520 located on the wall below the vapor source 510. In some implementations, the alkali metal vapor curtain 520 has the area of the interior wall subtended by a certain angular range (0), e.g., 15° to 90°, as shown in FIG. 5B.

The walls of the fusion reaction chamber 505 are kept cool by cooling conduit 550, which is attached to a coolant reservoir 560. Consequently, the alkali vapor forms alkali metal condensate 530 on the wall. Depending on the implementation, this region can be in a range from 20° C.-1,500° C. (e.g., 500° C. or more, 600° C. or more, 700° C. or more, 800° C. or more, up to 1,200° C. or less, 1,000° C. or less). A control unit 515, such as computer, can be connected to monitor and control the elements of the fusion reaction chamber and its related components.

Source gasses, such as hydrogen and helium, interact with the vapor and liquid forms of the alkali metal. The liquid compound formed by the reaction of hydrogen and helium with the alkali metal flow downward on the walls, eventually reaching a collection cup 540. Additionally, some of the alkali metal condensate 530 will flow into the collection cup 540. FIG. 5B shows a cross section of the fusion reaction chamber 505. In some implementations, a reinsertion channel 570 connects the collection cup 540 and vapor source 510. This allows the liquid alkali metal to be recycled by returning the liquid alkali metal to vapor source 510 where it is again vaporized and sprayed onto the interior wall of the chamber. Further, the reinsertion channel 570 can optionally be connected to another conduit to allow for the removal of pumped hydrogen and helium.

Due to the various phases of alkali metals in the diffusion pump, there are operating temperatures ranges specific to each region. The alkali metal vapor temperature can be above 600° C. The liquid region can be between 20° C.-1,500° C. (e.g., 500° C. or more, 600° C. or more, 700° C. or more, 800° C. or more, up to 1,200° C. or less, 1,000° C. or less). In the interior of the fusion reaction chamber 505, the temperature can vary based on the phase of the alkali metal and how much cold hydrogen and/or helium is present.

While the foregoing examples all feature the use of alkali metals as a working fluid in a diffusion pump for a fusion reactor, other uses are also contemplated. For example, such diffusion pumps can be used in other vacuum systems in which removal of hydrogen and/or helium is desired. In some implementations, such diffusion pumps aid in the production and/or refinement of alkali metals.

A number of embodiments have been described. Other embodiments are in the claims.

1. A method, comprising:
using an alkali metal as working fluid of a diffusion pump to remove hydrogen and/or helium from a reaction chamber of a nuclear fusion reactor.

2. The method of claim 1, wherein using the alkali metal comprises delivering a vapor of an alkali metal into a pump chamber containing the hydrogen and/or helium, under conditions so that the vapor of the alkali metal forms a condensate on at least one interior wall of the pump chamber.

3. The method of claim 2, wherein the condensate comprises the alkali metal.

4. The method of claim 2, wherein the condensate comprises a reaction product of the alkali metal and hydrogen.

5. The method of claim 2, wherein the condensate comprises a reaction product of the alkali metal and helium.

6. The method of claim 2, wherein the pump chamber containing the hydrogen and/or helium is a reaction chamber in which a nuclear fusion reaction occurs.

7. The method of claim 2, wherein the pump chamber is separate from and in fluid communication with a reaction chamber in which a nuclear fusion reaction occurs.

8. The method of claim 6, wherein the nuclear fusion reaction is a pB11 reaction.

9. The method of claim 2, further comprising removing the condensate from the chamber.

10. The method of claim 2, wherein using the alkali metal comprises heating the alkali metal prior to delivering the alkali metal into the pump chamber.

11. The method of claim 2, further comprising delivering a coolant to cool the interior wall of the chamber to provide the conditions to form the condensate.

12. The method of claim 7, further comprising energizing a plasma to ionize atomic helium entering the chamber.

13. The method of claim 2, wherein the alkali metal is lithium.

14. The method of claim 2, wherein the alkali metal is sodium.

15. The method of claim 2, wherein the alkali metal is potassium.

16. The method of claim 2, wherein the alkali metal is cesium.

17. The method of claim 2, wherein the alkali metal is rubidium.

18. A system, comprising:
a nuclear fusion reactor; and
a diffusion pump with a working fluid comprising an alkali metal, the diffusion pump being arranged to remove hydrogen and/or helium from the nuclear fusion reactor during operation of the system.

19. The system of claim 18, wherein the diffusion pump comprises:
a chamber arranged to receive hydrogen and/or helium from the nuclear fusion reactor;
a supply conduit comprising one or more nozzles for delivering a vapor comprising the alkali metal to the chamber; and
an exhaust conduit for removing a condensate of the vapor that forms on an interior chamber wall from the chamber.

20. The system of claim 19, wherein the chamber is a reaction chamber of the nuclear fusion reactor.

21-32. (canceled)
